(19) United States
(12) Patent Application Publication
(10) Pub. No.: US 2012/0152900 A1
(43) Pub. Date: Jun. 21, 2012

(54) METHODS AND APPARATUS FOR GAS DELIVERY INTO PLASMA PROCESSING CHAMBERS

(75) Inventors: ROBERT P. CHEBI, San Carlos, CA (US); STANLEY DETMAR, Mountain View, CA (US); ALAN CHESHIRE, Glasgow (GB); GABRIEL ROUPILLARD, Stockholm (SE); ALFREDO GRANADOS, San Antonio, TX (US)

(73) Assignee: APPLIED MATERIALS, INC., Santa Clara, CA (US)

(21) Appl. No.: 13/305,986

(22) Filed: Nov. 29, 2011

Related U.S. Application Data
(60) Provisional application No. 61/425,015, filed on Dec. 20, 2010.

(51) Int. Cl. C23F 1/00; C23F 1/08; H05H 1/24

(52) U.S. Cl. 216/67; 315/111.21; 156/345.33

(57) ABSTRACT

Methods and apparatus for gas delivery into plasma processing chambers are provided herein. In some embodiments, an apparatus for processing a substrate includes a process chamber having a processing volume, a substrate support disposed in the processing volume, an inductively coupled plasma source to generate an electric field within the processing volume that includes one or more regions of local maxima in the magnitude of the electric field, and one or more gas injectors to selectively direct a predominant portion of a process gas flowed through the one or more gas injectors into the one or more regions of local maxima.

### CROSS-REFERENCE TO RELATED APPLICATIONS

This application claims benefit of U.S. provisional patent application Ser. No. 61/425,015, filed Dec. 20, 2010, which is herein incorporated by reference

### BACKGROUND

1. Field

Embodiments of the present invention generally relate to methods and apparatus for processing substrates in plasma assisted processing chambers.

2. Description of the Related Art

To obtain process uniformity, process gases are typically delivered to a process chamber in a uniform pattern with respect to a substrate to be processed disposed in the process chamber. For example, a process gas may be provided into a processing volume directed towards a surface of a substrate to be processed (e.g., perpendicularly to the surface of the substrate) or directed across the surface of the substrate (e.g., parallel to the surface of the substrate). However, the inventors have observed that processing on the substrate is still often not uniform.

Thus, the inventors have provided improved methods and apparatus for delivering process gases to a plasma process chamber that may provide improved processing results.

### SUMMARY

Methods and apparatus for gas delivery into plasma processing chambers are provided herein. In some embodiments, an apparatus for processing a substrate includes a process chamber having a processing volume, a substrate support disposed in the processing volume, an inductively coupled plasma source to generate an electric field within the processing volume that includes one or more regions of local maxima in the magnitude of the electric field, and one or more gas injectors to selectively direct a predominant portion of a process gas flowed through the one or more gas injectors into the one or more regions of local maxima.

In some embodiments, a method of forming a plasma in a process chamber includes generating an electric field within a processing volume of the process chamber using an inductively coupled plasma source, wherein the processing volume includes one or more regions of local maxima in the magnitude of the electric field, and injecting a predominant portion of a process gas into the one or more regions to form a plasma in the processing volume. Other and further embodiments of the present invention are described below.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a sectional schematic of a plasma reactor in accordance with some embodiments of the present invention.

FIGS. 2A-B depict perspective views of gas injectors in accordance with some embodiments of the present invention.

FIG. 3A-C depict partial sectional schematics of a plasma reactor and gas injectors in accordance with some embodiments of the present invention.

FIG. 4 depicts a flow chart for a method of processing a substrate in accordance with some embodiments of the present invention.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

Methods and apparatus for delivering process gases to a plasma process chamber are provided herein. Although the apparatus and methods described herein may be particularly advantageous for etching silicon for MEMS applications, it is contemplated that the embodiments of the invention are not limited to use with silicon etching (or MEMS applications), but may be beneficially utilized to etch other types of materials and/or be utilized in other plasma-enhanced etch or non-etch reactors. The inventive methods and apparatus disclosed herein may advantageously provide improved plasma conversion efficiency resulting in one or more of improved processing uniformity or more efficient use of process gas resources.

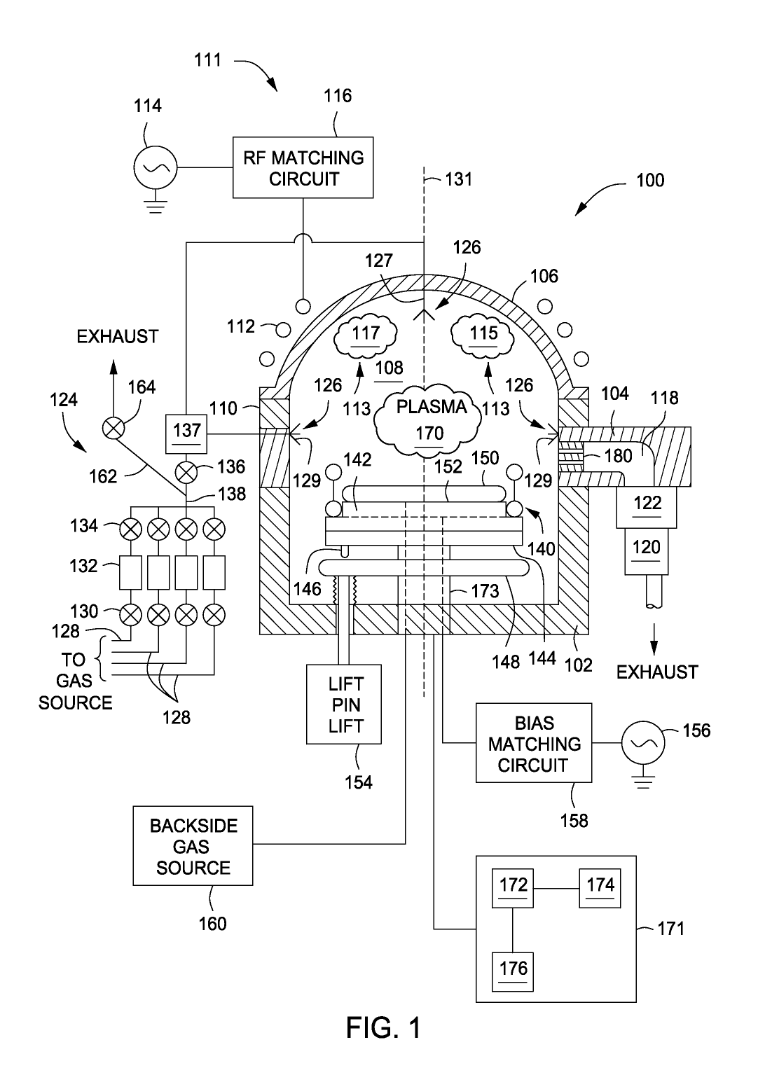

FIG. 1 depicts a sectional view of an plasma reactor 100 (e.g., a process chamber) in accordance with some embodiments of the present invention. The plasma reactor 100 includes a lower chamber body 102, an upper chamber body 104, and a ceiling 106 which enclose a processing volume 108. A substrate support 140 may be disposed in the processing volume 108. The ceiling 106 may be flat or have other geometry. In one embodiment, the ceiling 106 may be a domed ceiling, wherein one or more RF coils 112 are disposed above the domed ceiling. An interchangeable spacer 110 is provided between the ceiling 106 and the upper chamber body 104 so that the inclination and/or height of the ceiling 106 relative to the upper chamber body 104 may be selectively changed as desired.

An inductively coupled plasma source 111 may be used to generate an electric field with the processing volume 108. For example, the electric field may be utilized to ionize a process gas to facilitate the formation of a plasma, such as a plasma 170 as shown in FIG. 1. The inductively coupled plasma source may include one or more RF coils 112 disposed above the ceiling 106 and coupled to an RF source 114 through a matching circuit 116. The one or more RF coils 112 may be disposed externally to the processing volume 108 as illustrated. The ceiling 106 is transmissive to the RF power such that source power applied to the one or more RF coils 112 from the RF source 114 may be inductively coupled to and energize gases disposed in the processing volume 108 of the reactor 100 to maintain the plasma 170. Conventionally, the power applied to the one or more RF coils 112 is known as source power. The source power may be provided at a radio frequency within a range from about 2 MHz to about 60 MHz at a power within a range from about 10 watts to about 5000 watts. The source power may be pulsed.

The one or more RF coils 112 may be symmetric (as shown in FIG. 1) or asymmetric (not shown) to compensate for asymmetric pumping, for example, due to a pumping channel 118 being disposed asymmetrically with respect to the processing volume 108. A more detailed description of asymmetric RF coils and process chambers having such asymmetric RF coils can be found in United States patent application Ser. No. 61/407,882, filed Oct. 28, 2010, titled “Plasma Processing Apparatus with Reduced Effects of Process Chamber Asymmetry,” which is herein incorporated by reference in its entirety. For example, and regardless of an symmetric or asymmetric design of the one or more RF coils 112, the inductively coupled plasma source 111 may be used to generate an electric field within the processing volume 108 that includes one or more regions 113 of local maxima in the magnitude of the electric field. The one or more regions 113 may be symmetrically disposed about the ceiling or asymmetrically disposed depending on the configuration of the one or more RF coils 112. Further, the maximum of the electric field magnitude of each of the one or more regions may vary depending on the configuration of the one or more RF coils 112. For example, the one or more regions 113 can further comprise a first region 115 having a first local maximum in the magnitude of the electric field and a second region 117 having a second local maximum in the magnitude of the electric field that is different than the first local maximum (e.g., greater than or less than).

In some embodiments, the one or more regions 113 may be disposed in the processing volume 108 proximate a portion of the chamber ceiling 106 having an external side proximate, or adjacent to, the one or more RF coils 112. For example, local maxima in the magnitude of the electric field may occur proximate the one or more RF coils 112. Accordingly, the one or more regions 113 may be located proximate the one or more RF coils 112.

The upper chamber body 104 may include a pumping channel 118 that connects the processing volume 108 of the reactor 100 to a pump 120 through a throttle valve 122. The pump 120 and throttle valve 122 may be operated to control the pressure within the processing volume 108 of the reactor 100. The pump 120 also removes processing by-products. A baffle plate 180 may be disposed in the pumping channel 118 to minimize contamination of the pump 120 and to improve conductance within the processing volume 108. The pumping channel 118 may remove one or more gases from the processing volume 108. In some embodiments, the pumping channel 118 may be disposed asymmetrically with respect to the processing volume 108. For example, the asymmetric position of the pumping channel 118 may result in asymmetric process gas flow within the processing volume 108. For example, a portion of the processing volume 108 proximate the pumping channel 118 may have a lower pressure than a portion of the processing volume disposed away from the pumping channel 118. In some embodiments, pumping channel 118 may be disposed in a portion of the processing volume 118 that includes the first region 115. The second region 117 may be disposed in a portion of the processing volume disposed away from the pumping channel 118. For example, it may be desirable for the second region 117 to be located in a portion of the processing volume 108 having a higher pressure, for example, to facilitate improved plasma conversion efficiency of a process gas flowing in the chamber. For example, more process gas may be present in a portion of the processing volume 108 that is located away from the pump channel 118.

The reactor 100 may include a fast gas exchange system 124 coupled thereto that provides a process gas to the processing volume 108 through one or more injectors 126 positioned around the interior of the upper chamber body 104 and/or other suitable locations, such as in the ceiling 106. Alternatively, or in combination, any suitable gas delivery system may be coupled to the one or more injectors 126 to provide the process gas to the processing volume 108 in the manner as disclosed herein. Contrary to the conventional wisdom of directing the process gas perpendicularly towards the substrate or across the surface of the substrate, the one or more injectors 126 may be used to direct a predominant portion of the process gas flowed through the one or more injectors 126 into the one or more regions 113 of local maxima. The regions 113 of local maxima in the electric field provided by the plasma source may not be located proximate a location where injectors conventionally inject the process gas into the processing chamber. Accordingly, plasma conversion efficiency of the process gas may be low or uneven, and may result in non-uniformities on the substrate or wasted process gas resources. The inventors have unexpectedly discovered that by providing the process gas (or a predominant portion thereof) to the regions of local maxima, rather than directly to the substrate, processing rates, such as etch rates, may be enhanced without sacrificing process uniformity.

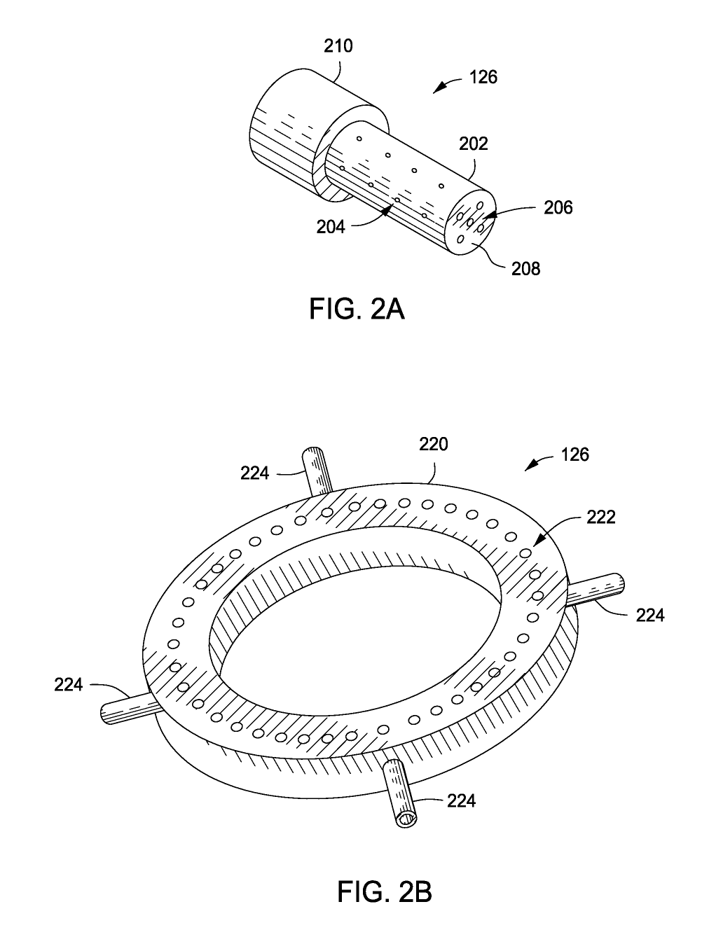

The one or more injectors 126 may have a variety of configurations suitable to provide the process gas to the one or more regions 113 of local maxima. For example, FIGS. 2A-B depict perspective views of two different types of injectors 126. As shown in FIG. 2A, the injector 126 may be a hollow member 202, such as a cylinder or tube, having one or more holes 204 formed through the walls of the member 202. An end 208 of the member 202 is sealed to prevent the process gas from flowing through the end of the member 202. Optionally, one or more holes 206 may be provided in the end 208 to allow some of the process gas to flow therethrough. The member 202 may have a portion 210 having an enlarged outer diameter or some other feature to facilitate mounting, coupling, positioning, and/or sealing the injector 126 in position with respect to the plasma reactor 100.

In some embodiments, as shown in FIG. 2B, the injector 126 may comprise a hollow member 220 having a closed shape with an open interior (e.g., a ring or the like) having a plurality of holes 222 formed through the walls of the member 220. The plurality of holes 222 may be arranged in any geometry, such as azimuthally uniformly, grouped into regions, randomly, or the like, suitable to provide a predominant portion of the process gas to the regions 113 of local maxima. The open interior of the member 220 may be sized to be larger than a substrate to be processed in the plasma reactor 100 to minimize interference with the process. One or more conduits 224 may be provided to couple the hollow member 220 to a gas source and provide the process gases to the plasma reactor 100. The conduits 224 may also support the hollow member 220 within the plasma reactor 100. Alternatively or on combination, other supports (not shown) may be provided to support the member 220 in place.

In some embodiments, as illustrated in FIG. 1, the one or more injectors 126 may include a first injector 127 disposed in or near the chamber ceiling 106 of the process chamber, along a central axis 131 of the substrate support 140. Alternatively or in combination, the one or more injectors 126 may include one or more second injectors 129 disposed on or near a sidewall of the process chamber. The one or more second injectors 129 may be disposed above the substrate support 140 and about the central axis 131 of the substrate support 140.

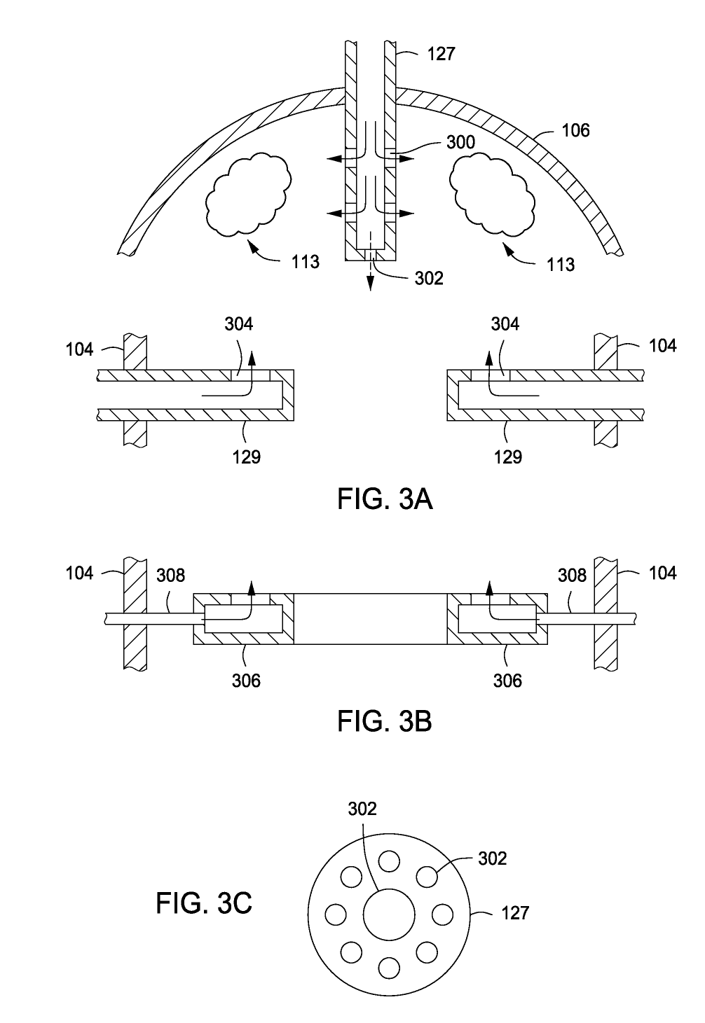

First and second injectors 127, 129 in accordance with some embodiments of the present invention are illustrated in further detail in FIGS. 3A-C. For example, FIG. 3A depicts a partial schematic view of the plasma reactor 100 in accordance with some embodiments of the present invention. As illustrated in FIG. 3A, the first injector 127 may be disposed through the chamber ceiling 106 and may be centrally located in the chamber ceiling 106. As discussed above, the first injector 127 may be disposed along the central axis 131 of the substrate support 140 (not shown in FIG. 3A).

The first injector 127 may include one or more holes 300 configured to inject the process gas into the desired region of the processing volume (e.g., into the regions 113 of local maxima). In some embodiments, the holes 300 may be oriented perpendicular to the central axis 131 of the substrate support 140 to inject the process gas into the processing volume 108 in a direction substantially parallel to a processing surface of the substrate support 140. For example, the one or more regions 113 may be located about the first injector 127 as shown in FIG. 3A. Accordingly, the one or more holes 300 may be oriented perpendicular to the central axis 131 to facilitate a maximum amount of process gas being injected into the one or more regions 113. The one or more holes 300 may be disposed about the first injector 127. However, other configurations and geometries of the holes may be provided to deliver the process gas predominantly to the regions 113 of local maxima. Optionally, in some embodiments, the first injector 127 may further include one or more holes 302 oriented to provide a portion of the process gas towards the substrate support 140. For example, the one or more holes 302 may be disposed in a substrate support facing surface of the first injector 127 as illustrated in FIG. 3A. Further, the one or more holes 302 may be arranged in any desirable pattern and/or variety of sizes on the substrate support facing surface of the first injector 127, for example, an exemplary pattern of the one or more holes 302 is illustrated in FIG. 3C.

Returning to FIG. 3A, the one or more second injectors 129 may be disposed proximate a sidewall of the process chamber. For example, the second injectors 129 may be formed in the sidewalls, coupled to the sidewalls, or otherwise held in position near the sidewalls of the process chamber, In some embodiments, as shown in FIG. 3A, the second injectors 129 may extend through and be supported by the chamber sidewall in a suitable location, such as in the upper chamber body 104. The one or more second injectors 129 may be arranged in any suitable pattern about the central axis 131 of the substrate support 140. In some embodiments, there may be a plurality of second injectors, for example, four second injectors 129, evenly spaced about the central axis 131. The one or more second injectors 129 may include one or more holes 304 oriented to direct a predominant portion of the process gas into the one or more regions 113 of local maxima. In some embodiments, the one or more holes 304 may be directed toward the ceiling 106 or may face the ceiling 106, of the process chamber. In some embodiments, the one or more holes 106 may be configured to inject the process gas into the one or more regions 113 in a direction that is substantially opposing to a processing surface of the substrate support 140. The one or more second injectors 129 may further include one or more holes (not shown) to provide the process gas in a direction towards the substrate support 140. As discussed below, a flow rate of the process gas from each of the one or more second injectors 129 may be individually controlled, for example, by one or more flow ratio controllers (such as flow ratio controller 137) or the like.

Variations of the one or more injectors 126 are contemplated. For example, alternatively to or in combination with the one or more first injectors 127, or the one or more second injectors 129, the one or more injectors 126 may comprise an injector ring 306. The injector ring 306 may be disposed above and coaxially with the substrate support 140. The injector ring 306 may have a diameter exceeding a diameter of the substrate support 140, or exceeding a diameter of a substrate disposed on the substrate support. The injector ring 306 may include one or more conduits 308 coupled to a gas supply, for example, through a sidewall or ceiling of the process chamber, to provide a process gas to the injector ring 306. In some embodiments, a flow rate of the process gas can be varied to different sections of the injector ring 306 such as by connecting the one or more conduits 308 to the outlets to a flow ratio controller, independent flow controllers, independent gas sources, or the like, to vary the flow rate to each section.

Returning to FIG. 1, the fast gas exchange system 124 selectively allows any singular process gas or combination of process gases to be provided to the processing volume 108. In some embodiments, the fast gas exchange system 124 has four delivery lines 128, each coupled to a different gas source. The delivery lines 128 may be coupled to the same or different one or more injectors 126.

In the embodiment depicted in FIG. 1, each delivery line 128 includes a first valve 130, a mass flow meter 132, and a second valve 134. The second valves 134 are coupled to a common tee 138, which is coupled to the one or more injectors 126. The conduits through which gases flow from mass flow meters 132 to the processing volume 108 is less than about 2.5 m in length, there by allowing faster switching times between gases. The fast gas exchange system 124 may be isolated from the processing volume 108 of the reactor 100 by an isolation valve 136 disposed between the tee 138 and one or more injectors 126. In some embodiments, a flow ratio controller 137 may be coupled to the one or more second injectors 129 to control the flow rate of the process gas to each second injector 129.

An exhaust conduit 162 is coupled between the isolation valve 136 and the tee 138 to allow residual gases to be purged from the fast gas exchange system 124 without entering the reactor 100. A shut off valve 164 is provided to close the exhaust conduit 162 when gases are delivered to the processing volume 108 of the reactor 100.

The plasma reactor 100 additionally includes the substrate support 140 disposed in the processing volume 108. The substrate support 140 may includes a substrate support and/or retention mechanism, such as an electrostatic chuck 142 mounted on a thermal isolator 144. The thermal isolator 144 insulates the electrostatic chuck 142 from a stem 173 that supports the electrostatic chuck 142 above the bottom of the lower chamber body 102.

In some embodiments, lift pins 146 may be disposed through the substrate support 140. A lift plate 148 is disposed below the substrate support 140 and may be actuated by a lift 154 to selectively displace the lift pins 146 to lift and/or place a substrate 150 on an upper surface 152 of the electrostatic chuck 142.

The electrostatic chuck 142 may include at least one electrode (not shown) which may be energized to electrostatically retain the substrate 150 to the upper surface 152 of the electrostatic chuck 142. In some embodiments, an electrode of the electrostatic chuck 142, or some other electrode disposed in the substrate support, may be coupled to a bias power source 156 through a matching circuit 158. The bias power source 156 may selectively energize the electrode to control the directionality of the ions during processing (e.g., to direct the ions more vertically towards the substrate with more energy).

In some embodiments, the bias power applied to the substrate support by the bias power source 156 may be pulsed, e.g. repeatedly storing or collecting the energy over a time period and then rapidly releasing the energy over another time period to deliver an increased instantaneous amount of power, while the source power may be continuously applied. In particular, the bias power may be pulsed using generator pulsing capability set by a control system to provide a percentage of time that the power is on, which is referred to as the “duty cycle.” In one embodiment, the time on and the time off of a pulsed bias power may be uniform throughout the processing cycles. For example, if the power is on for about 3 msec and off for about 15 msec, then the duty cycle would be about 16.67%. The pulsing frequency in cycles per second or hertz (Hz) is equal to 1.0 divided by the sum of the on and off time periods in seconds. For example, when the bias power is on for about 3 msec and off for about 15 msec, for a total of about 18 msec, then the pulsing frequency in cycles per second is about 55.55 Hz.

Optionally, in some embodiments a backside gas source 160 may be coupled through the substrate support 140 to provide one or more gases to a space (not shown) defined between the substrate 150 and the upper surface 152 of the electrostatic chuck 142. Gases provided by the backside gas source 160 may include helium (He) and/or a backside process gas.

In some embodiments, the plasma reactor 100 may include a controller 171 which generally comprises a central processing unit (CPU) 172, a memory 174, and support circuits 176 and is coupled to and controls the plasma reactor 100 and various system components, such as the RF source 114, fast gas exchange system 124 and the like, directly (as shown in FIG. 1) or, alternatively, via computers (or controllers) associated with the process chamber and/or the support systems. The controller 170 may be one of any form of general-purpose computer processor that can be used in an industrial setting for controlling various chambers and sub-processors. The memory, or computer-readable medium, 174 of the CPU 172 may be one or more of readily available memory such as random access memory (RAM), read only memory (ROM), floppy disk, hard disk, or any other form of digital storage, local or remote. The support circuits 176 are coupled to the CPU 172 for supporting the processor in a conventional manner. These circuits include cache, power supplies, clock circuits, input/output circuitry and subsystems, and the like. The memory 174 stores software (source or object code) that may be executed or invoked to control the operation of the reactor 100 in the manner described herein, for example, to perform the method 400 described below.

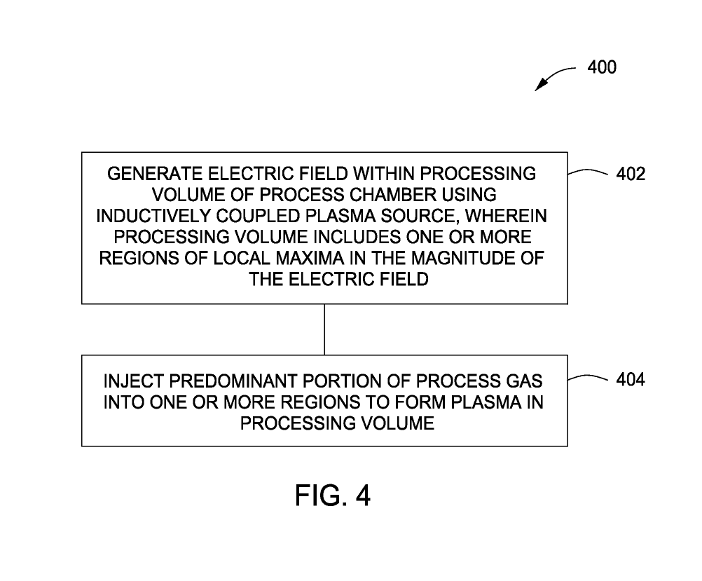

FIG. 4 depicts a flow chart for a method 400 of forming a plasma in a process chamber in accordance with some embodiments of the present invention. The method 400 may be practiced in the plasma reactor 100 or other suitable plasma reactor. The method 400 is described below in accordance the plasma reactor 100.

The method 400 begins at 402 by generating an electric field with the processing volume 108 of the process chamber using the inductively coupled plasma source 111, wherein the processing volume 108 includes one or more regions 113 of local maxima in the magnitude of the electric field. As discussed above, the one or more regions 113 may be located proximate the one or more RF coils 112 of the inductively coupled plasma source 111. Further, due to variations, such as shape of the one or more RF coils 112 or the like, the one or more regions may include a first region 115 having a first local maximum in the magnitude of the electric field and a second region having a second local maximum in the magnitude of the electric field that is great than the first local maximum.

At 404, a predominant portion of the process gas is injected into the one or more regions 113 to form a plasma (e.g., plasma 170) in the processing volume 108. For example, as illustrated in FIGS. 3A-C and discussed above, the first and second injectors 127, 129 may have one or more holes that are specifically oriented to inject a predominant portion of the process gas in the one or more regions 113. For example, the predominant portion of the process gas may be injected in a direction opposing a processing surface of the substrate support 140, e.g., using the one or more second injectors 129 via the one or more holes 304. Alternatively, or in combination with, the predominant portion of the process gas may be injected in a direction substantially parallel to a processing surface of the substrate support 140, e.g., using the first injector 127 via the one or more holes 300. The direction of injection of the process gas may be such that the predominant portion of the process gas is injected into the one or more regions 113.

In some embodiments, the flow rate of the process gas may be varied, for example, to compensate for asymmetric pumping on the processing volume 108 and/or asymmetry in the one or more regions 113. For example, due to variations as discussed above, a predominant portion of the process gas may be injected into the first region 115 at a first flow rate and a predominant portion of the process gas may be injected into the second region 117 at a second flow rate greater than the first flow rate. For example, the injection of the predominant portion of the process gas into the first and second regions 115, 117 may be controlled by the flow ratio controller 137 which may vary the flow rate to each of the second injectors 129. For example, a higher flow rate at the second region 117 may be desired due to one or more of the second region 117 having a greater magnitude of electric field or the second region 117 being included in a portion of the processing volume 108 having a higher pressure due to asymmetric pumping. For example, the flow rate ratio between the first and second regions 115, 117 may be varied as desired such that the substrate 150 is processed uniformly by the plasma 170 generated in the plasma reactor 100.

While the foregoing is directed to embodiments of the invention, other and further embodiments of the invention may be devised without departing from the basic scope thereof.

What is claimed is:

1. An apparatus for processing a substrate, comprising:
a process chamber having a processing volume;
a substrate support disposed in the processing volume;
an inductively coupled plasma source to generate an electric field within the processing volume that includes one or more regions of local maxima in the magnitude of the electric field; and
one or more injectors to selectively direct a predominant portion of a process gas flowed through the one or more injectors into the one or more regions of local maxima.

2. The apparatus of claim 1, wherein the inductively coupled plasma source further comprises:
one or more RF coils disposed externally to the processing volume.

3. The apparatus of claim 2, wherein the process chamber further comprises:
a domed ceiling, wherein the one or more RF coils are disposed about the domed ceiling.

4. The apparatus of claim 2, wherein the one or more regions are disposed in the processing volume proximate a portion of a chamber ceiling having an external side proximate the one or more RF coils.

5. The apparatus of claim 1, wherein the one or more injectors further comprises:
a first injector disposed in a chamber ceiling of the process chamber and along a central axis of the substrate support.

6. The apparatus of claim 5, wherein the first injector further comprises:
one or more holes oriented perpendicular to the central axis of the substrate support to inject the process gas into the processing volume in a direction substantially parallel to a processing surface of the substrate support.

7. The apparatus of claim 1, wherein the one or more injectors further comprises:
one or more second injectors protruding from walls of the process chamber, wherein the one or more second injectors are disposed at a height above the substrate support and about the central axis of the substrate support.

8. The apparatus of claim 7, wherein the one or more second injectors further comprise:
one or more holes oriented to face a ceiling of the process chamber to inject the process gas into the one or more regions in a direction substantially opposite a processing surface of the substrate support.

9. The apparatus of claim 7, wherein the one or more second injectors comprises a plurality of second injectors and further comprising:
one or more flow ratio controllers coupled to the plurality of second injectors to control a relative flow rate of the process gas to each second injector in the plurality.

10. The apparatus of claim 9, wherein the one or more regions further comprise:
a first region having a first local maximum in the magnitude of the electric field; and
a second region having a second local maximum in the magnitude of the electric field that is greater than the first local maximum.

11. The apparatus of claim 10, further comprising:
a pump channel to remove one or more gases from the processing volume, wherein the pump channel is disposed asymmetrically with respect to the processing volume and wherein the pump channel is disposed in a portion of the processing volume which includes the first region.

12. The apparatus of claim 1, wherein the one or more injectors further comprises:
a hollow member having a closed shape with an open interior and having a plurality of holes formed through walls of the hollow member to fluidly couple the hollow member to the processing volume, wherein the open interior is larger than a substrate support surface of the substrate support.

13. The apparatus of claim 12, wherein the plurality of holes are grouped into regions to provide a predominant portion of the process gas to the regions of local maxima.

14. The apparatus of claim 12, further comprising:
one or more conduits to couple the hollow member to a gas source and provide the process gases to the processing volume.

15. A method of forming a plasma in a process chamber, comprising:
generating an electric field within a processing volume of the process chamber using an inductively coupled plasma source, wherein the processing volume includes one or more regions of local maxima in the magnitude of the electric field; and
injecting a predominant portion of a process gas into the one or more regions to form a plasma in the processing volume.

16. The method of claim 15, wherein the one or more regions further comprise:
a first region having a first local maximum in the magnitude of the electric field; and
a second region having a second local maximum in the magnitude of the electric field that is greater than the first local maxima.

17. The method of claim 16, wherein injecting the predominant portion of the process gas further comprises:
injecting the predominant portion of the process gas into the first region at a first flow rate; and
injecting the predominant portion of the process gas in the second region at a second flow rate greater than the first flow rate.

18. The method of claim 17, further comprising:
pumping asymmetrically on the processing volume, wherein a first pressure in a first portion of the processing volume that includes the first region is greater than a second pressure in a second portion of the processing volume that includes the second region.

19. The method of claim 16, wherein injecting the predominant portion of the process gas further comprises:
injecting the predominant portion of the process gas in a direction opposing a processing surface of a substrate support disposed within the processing volume.

20. The method of claim 16, wherein injecting the predominant portion of the process gas further comprises:
injecting the predominant portion of the process gas in a direction substantially parallel to a processing surface of a substrate support disposed with the processing volume.
